(19) United States
(12) Patent Application Publication
(10) Pub. No.: US 2009/0095416 A1
(43) Pub. Date: Apr. 16, 2009

(54) METHOD FOR MANUFACTURING HONEYCOMB STRUCTURE

(75) Inventors: Masafumi KUNIEDA, Ibi-gun (JP); Mari KITAJIMA, Ibi-gun (JP)

Correspondence Address: DITTHAVONG MORI & STEINER, P.C., 918 Prince St., Alexandria, VA, 22314, US

(73) Assignee: IBIDEN CO., LTD., Ogaki-shi (JP)

(21) Appl. No.: 12/194,888

(22) Filed: Aug. 20, 2008

(30) Foreign Application Priority Data
Oct. 15, 2007 (JP) PCT/JP2007/070097

(51) Int. Cl. B32B 37/02; B29C 65/00; C04B 35/00

(52) U.S. Cl. 156/280; 156/296; 501/134

(57) ABSTRACT

A method for manufacturing a honeycomb structure includes molding a raw material composition to manufacture a plurality of honeycomb molded bodies. Each of the plurality of honeycomb molded bodies has a number of cells longitudinally placed substantially in parallel with one another with a cell wall interposed therebetween. The plurality of honeycomb molded bodies are fired to manufacture a plurality of honeycomb fired bodies. A water retention adhesive paste containing a water retention agent is prepared. The plurality of honeycomb fired bodies are bonded to one another by using the water retention adhesive paste and forming an adhesive layer to manufacture a honeycomb aggregated body.

### CROSS-REFERENCE TO RELATED APPLICATIONS

The present application claims priority under 35 U.S.C. §119 to PCT Application No. PCT/JP2007/070097, filed Oct. 15, 2007, the contents of which are incorporated herein by reference in their entirety.

### BACKGROUND OF THE INVENTION

1. Field of the Invention

This invention relates to a method for manufacturing a honeycomb structure.

2. Discussion of the Background

Honeycomb catalysts have been used in order to convert exhaust gases discharged from internal combustion engines of vehicles, such as buses and trucks, construction machines and the like. As a conventional honeycomb catalyst, for example, there has been proposed a cordierite-based honeycomb structure having an integral structure and a low thermal expansion with the surface supporting a catalyst metal such as platinum as well as a large specific surface area material such as activated alumina. In addition, a honeycomb catalyst having an alkali-earth metal such as Ba supported thereon as a NOₓ absorber has also been proposed, and this honeycomb catalyst is designed for use in converting NOₓ in an atmosphere with excessive oxygen, such as an atmosphere in a lean burn engine and a diesel engine.

There has been known a honeycomb structure including a honeycomb fired body which is manufactured as follows: a honeycomb shape is formed by adding inorganic fibers serving as a reinforcing material and an inorganic binder to a high specific surface area material such as activated alumina as a main raw material, and then fired. Also, an aggregated honeycomb structure formed by bonding a plurality of these honeycomb fired bodies with one another with an adhesive layer interposed therebetween has been known (for example, see JP-A 2005-349378).

Several methods have been disclosed as a method for bonding honeycomb fired bodies to one another during manufacturing processes of an aggregated honeycomb structure. In particular, a method for bonding a honeycomb fired bodies has been disclosed in which an adhesive paste layer containing inorganic particles, inorganic fibers and the like is formed between the side faces of the honeycomb fired bodies, and dried to form an adhesive layer for bonding the honeycomb fired bodies to one another.

Moreover, WO05/047210 A1 has disclosed a method, as a method for forming an adhesive paste layer between honeycomb fired bodies, in which a gap between honeycomb fired bodies (porous ceramic members) is filled with an adhesive paste as follows: manufacturing a parallel-arranged body (aggregated body of ceramic members) of the honeycomb fired bodies by assembling a plurality of honeycomb fired bodies with a gap holding member interposed therebetween; placing the parallel-arranged body formed by the assembled honeycomb fired bodies in a cylindrical jig; and applying pressure after the adhesive paste is allowed to flow into the gap.

The contents of JP-A 2005-349378 and WO05/047210 A1 are incorporated herein by reference in their entirety.

### SUMARRY OF THE INVENTION

According to one aspect of the present invention, a method for manufacturing a honeycomb structure includes molding a raw material composition to manufacture a plurality of honeycomb molded bodies. Each of the plurality of honeycomb molded bodies has a number of cells longitudinally placed substantially in parallel with one another with a cell wall interposed therebetween. The plurality of honeycomb molded bodies are fired to manufacture a plurality of honeycomb fired bodies. A water retention adhesive paste containing a water retention agent is prepared. The plurality of honeycomb fired bodies are bonded to one another by using the water retention adhesive paste and forming an adhesive layer to manufacture a honeycomb aggregated body.

According to another aspect of the present invention, a method for manufacturing a honeycomb structure includes molding a raw material composition to manufacture a plurality of honeycomb molded bodies. Each of the plurality of honeycomb molded bodies has a number of cells longitudinally placed substantially in parallel with one another with a cell wall interposed therebetween. The plurality of honeycomb molded bodies are fired to manufacture a plurality of honeycomb fired bodies. A water repellent layer is formed on a side face of each of the plurality of honeycomb fired bodies. The plurality of honeycomb fired bodies are bonded to one another by using an adhesive paste and forming an adhesive layer to manufacture a honeycomb aggregated body.

According to further aspect of the present invention, a method for manufacturing a honeycomb structure includes molding a raw material composition to manufacture a plurality of honeycomb molded bodies. Each of the plurality of honeycomb molded bodies has a number of cells longitudinally placed substantially in parallel with one another with a cell wall interposed therebetween. The plurality of honeycomb molded bodies are fired to manufacture a plurality of honeycomb fired bodies. A base adhesive paste layer having a moisture content is formed on a side face of each of the plurality of honeycomb fired bodies. The plurality of honeycomb fired bodies are bonded to one another by using an adhesive paste and forming an adhesive layer to manufacture a honeycomb aggregated body.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1A is a cross-sectional view that schematically shows one example of a cross section of a conventional filling apparatus and a parallel-arranged body of honeycomb fired bodies placed in the filling apparatus, the view being taken perpendicular to the longitudinal direction of the parallel-arranged body, and FIG. 1B is a cross-sectional view that schematically shows one example of a cross section of the filling apparatus of an adhesive paste and the parallel-arranged body of honeycomb fired bodies placed in the filling apparatus of FIG. 1A, the view being taken parallel to the longitudinal direction thereof.

FIG. 2 is a cross-sectional view that schematically shows a neighborhood of a side face (area indicated by D in FIG. 1B) of a honeycomb fired body upon filling an adhesive paste therein, in a conventional method for manufacturing a honeycomb structure.

FIG. 3 is a cross-sectional view that schematically shows a neighborhood of a side face of a honeycomb fired body upon filling a water retention adhesive paste containing a water retention agent in the method for manufacturing a honeycomb structure according to one embodiment of the first invention.

FIG. 4 is a cross-sectional view that schematically shows a neighborhood of a side face of a honeycomb fired body upon filling with an adhesive paste after formation of a water repellent layer on the side face of the honeycomb fired body in the method for manufacturing a honeycomb structure according to one embodiment of the second invention.

FIG. 5 is a cross-sectional view that schematically shows a neighborhood of a side face of a honeycomb fired body upon filling with an adhesive paste after formation of a base adhesive paste layer on the side face of the honeycomb fired body in the method for manufacturing a honeycomb structure according to one embodiment of the third invention.

FIG. 6A is a perspective view schematically showing one example of a honeycomb structure according to embodiments of the first to third inventions, and FIG. 6B is a perspective view schematically showing one example of a honeycomb fired body.

FIG. 7 is a flow chart that illustrates main processes of a method for manufacturing a honeycomb structure according to the embodiment of the first invention in which a honeycomb structure is manufactured by using a water retention adhesive paste containing a water retention agent.

FIG. 8 is a flow chart that illustrates main processes of a method for manufacturing a honeycomb structure according to the embodiment of the second invention in which a water repellent layer is formed on a side face of a honeycomb fired body.

FIG. 9 is a flow chart that illustrates main processes of a method for manufacturing a honeycomb structure according to the embodiment of the third invention in which a base adhesive paste layer is formed on a side face of a honeycomb fired body.

### DESCRIPTION OF THE EMBODIMENTS

The embodiments will now be described with reference to the accompanying drawings, wherein like reference numerals designate corresponding or identical elements throughout the various drawings.

The method for manufacturing a honeycomb structure according to one embodiment of the first invention includes: molding a raw material composition to manufacture a honeycomb molded body having a large number of cells longitudinally placed substantially in parallel with one another with a cell wall interposed therebetween; firing the honeycomb molded body to manufacture a honeycomb fired body; preparing a water retention adhesive paste containing a water retention agent; and bonding a plurality of the honeycomb fired bodies to one another by using the water retention adhesive paste and forming an adhesive layer to manufacture a honeycomb aggregated body.

A method for manufacturing a honeycomb structure according to the embodiment of the first invention makes it easier to form an adhesive paste layer with high working efficiency by preventing deterioration of the flowability of the adhesive paste upon filling with an adhesive paste. This will be discussed hereinbelow.

First, problems occurring in conventional methods for manufacturing a honeycomb structure are described hereinbelow.

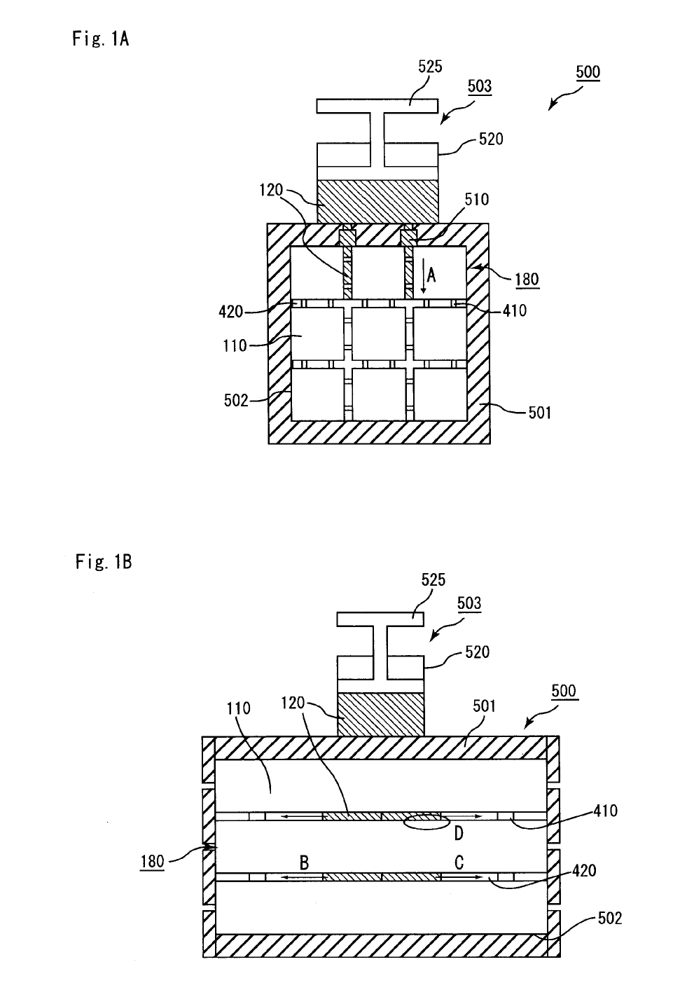

FIG. 1A is a cross-sectional view that schematically shows one example of a cross section of a conventional filling apparatus and a parallel-arranged body of honeycomb fired bodies placed in the filling apparatus, the view being taken perpendicular to the longitudinal direction of the parallel-arranged body, and FIG. 1B is a cross-sectional view that schematically shows one example of a cross section of a conventional filling apparatus and a parallel-arranged body of honeycomb fired bodies placed in the filling apparatus of FIG. 1A, the view being taken parallel to the longitudinal direction of the parallel-arranged body.

A filling apparatus 500 is provided with a tubiform 501 and a paste supply device 503. The tubiform 501 is provided with an inner space 502 which is allowed to accommodate a parallel-arranged body 180 of honeycomb fired bodies. The paste supply device 503 is provided with a paste chamber 520 for housing an adhesive paste 120 and an extruding mechanism 525 for extruding the adhesive paste 120 out of the paste chamber.

The tubiform 501 has an opening 510 formed thereon for allowing the paste chamber 520 and the inner space 502 to communicate with each other. The adhesive paste 120 is supplied through this opening 510.

Here, within the inner space 502, a plurality of honeycomb fired bodies 110 are placed horizontally and vertically side-by-side with a gap holding member (spacer) 410 interposed therebetween so that a gap 420 corresponding to the thickness of the spacer is formed between the honeycomb fired bodies 110.

In FIGS. 1A and 1B, arrows A, B and C in solid lines indicate directions of the adhesive paste to flow upon filling the gap 420 between the honeycomb fired bodies by using the filling apparatus.

That is, as the pressure is applied to the adhesive paste 120 by using the extruding mechanism 525, the gap 420 is filled with the adhesive paste 120 from the paste chamber 520 through the opening 510 so that the gap 420 is filled from the top to the bottom in FIG. 1A, while in FIG. 1B, the gap 420 is filled from the center to the right and left sides.

Use of such a filling apparatus allows the gap between the honeycomb fired bodies to be filled with the adhesive paste, and lastly, the adhesive paste to reach the neighborhood of both ends of the honeycomb fired bodies.

Honeycomb fired bodies for use as a catalyst supporting carrier such as disclosed in JP-A 2005-349378 is manufactured by firing inorganic particles with a high specific surface area, inorganic fibers and the like, and consequently tends to have a high water-absorbing property.

In addition, the adhesive paste used for filling contains inorganic particles, inorganic fibers and the like, and also contains much moisture so as to have a reduced viscosity and improved flowability.

For this reason, contact of an adhesive paste with such a honeycomb fired body may cause absorption of a portion of moisture contained in the adhesive paste into the honeycomb fired body.

In the case where the amount of the moisture contained in the adhesive paste decreases resulting from absorption into the honeycomb fired body, the viscosity of the adhesive paste sometimes increases to deteriorate the flowability of the adhesive paste.

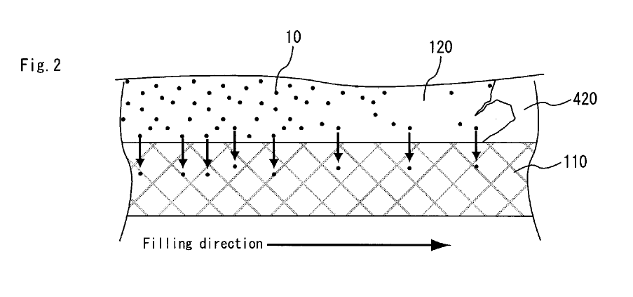

FIG. 2 is a cross-sectional view that schematically shows a neighborhood of a side face of a honeycomb fired body (region indicated by D in FIG. 1B) upon filling with the adhesive paste in a conventional method for manufacturing a honeycomb structure.

In FIG. 2, the direction to be filled with the adhesive paste is from left to right.

Moreover, in FIG. 2, moisture 10 contained in the adhesive paste 120 is schematically indicated by black dots, and a portion having many black dots has a great amount of moisture, while a portion having few black dots has a small amount of moisture.

The adhesive paste 120 is a paste containing much moisture 10, as shown on the left side of FIG. 2. Here, the gap 420 between honeycomb fired bodies is gradually filled with adhesive paste 120 from the left side toward the right side in FIG. 2. Since the adhesive paste 120 is having contact with the honeycomb fired body 110, the moisture 10 contained in the adhesive paste 120 is gradually absorbed into the honeycomb fired body 110 from the adhesive paste 120, as indicated by a downward arrow in FIG. 2.

As the moisture 10 contained in the adhesive paste 120 is absorbed into the honeycomb fired body 110, the moisture 10 contained in the adhesive paste 120 gradually decreases. That is, as filling with the adhesive paste 120 proceeds to the right side of FIG. 2, the moisture 10 contained in the adhesive paste 120 decreases.

Consequently, the number of the dots indicating the moisture 10 becomes smaller on the right side of FIG. 2.

When the moisture contained in the adhesive paste decreases, the viscosity of the adhesive paste increases to deteriorate the flowability of the adhesive paste. For this reason, it sometimes becomes difficult to fill up to the neighborhood of the end face of the honeycomb fired body with the adhesive paste.

Moreover, the adhesive paste is dried up at the leading portion of the adhesive paste, possibly resulting in occurrence of cracks in the adhesive paste.

Here, in order to fill up to the neighborhood of the end face of the honeycomb fired body with the adhesive paste having a low flowability, for example, it is necessary to use the following methods: applying a pressure higher than that normally applied to the adhesive paste; separately filling with the adhesive paste also from the end face of the honeycomb fired body; and the like. However, in both of these methods, there is a problem of a reduction in the working efficiency for forming an adhesive paste layer.

In contrast to the conventional method for manufacturing a honeycomb structure, the adhesive paste containing the water retention agent is prepared and the bonding process is carried out by using the adhesive paste containing the water retention agent in the method for manufacturing a honeycomb structure according to the embodiment of the first invention.

With reference to the figure, the following description will discuss effects of the method in which the adhesive paste containing the water retention agent is used.

Here, in the first invention, the water retention agent has such a property that it absorbs moisture and prevents the moisture from moving to another portion upon contact with the moisture.

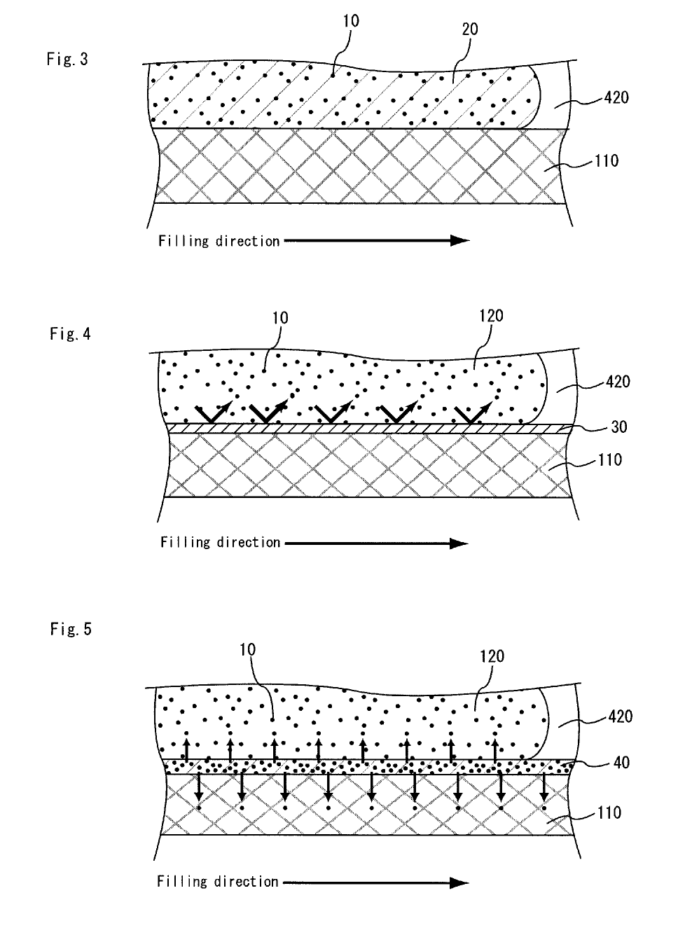

FIG. 3 is a cross-sectional view that schematically shows a neighborhood of a side face of a honeycomb fired body upon filling a water retention adhesive paste containing a water retention agent in the method for manufacturing a honeycomb structure according to the embodiment of the first invention.

In FIG. 3, a water retention adhesive paste 20 corresponding to the adhesive paste containing the water retention agent is indicated by slanting lines, and the moisture 10 is contained in the water retention adhesive paste 20.

Since the moisture 10 having contact with the water retention agent is hardly allowed to move to another portion, the moisture 10 contained in the water retention adhesive paste 20 is hardly allowed to move to another portion from the water retention adhesive paste 20. Consequently, even when the water retention adhesive paste 20 and the honeycomb fired body 110 make contact with each other, the moisture 10 contained in the water retention adhesive paste 20 is hardly absorbed into the honeycomb fired body 110. Therefore, even when the gap 420 between the honeycomb fired bodies is filled with the water retention adhesive paste 20 toward the right side of FIG. 3, the amount of moisture contained in the water retention adhesive paste 20 hardly decreases.

Therefore, in FIG. 3, the dots indicating the moisture 10 are distributed virtually uniformly from the left side to the right side of the adhesive paste 20.

For this reason, it may become easier to fill up to the neighborhood of the end face of the honeycomb fired body with the water retention adhesive paste while keeping the low viscosity and high flowability of the water retention adhesive paste.

Therefore, filling with the water retention adhesive paste tends to be carried out by applying low pressure to the water retention adhesive paste. Additionally, the adhesive paste layer tends to be formed with high working efficiency without necessity of separate filling with the adhesive paste from the end face of the honeycomb fired body.

In the method for manufacturing a honeycomb structure according to the embodiment of the first invention, the water retention agent includes a water absorbing polymer, a high porosity adhesive, montmorillonite, vermiculite or saponite.

Since these components have a water retention property, the water retention adhesive paste containing any of these components makes it easier to prevent the moisture in the water retention adhesive paste from being absorbed into the honeycomb fired body.

In the method for manufacturing a honeycomb structure according to the embodiment of the first invention, the raw material composition includes inorganic particles, at least one of inorganic fibers and whiskers, and an inorganic binder.

In the method for manufacturing a honeycomb structure according to the embodiment of the first invention, the inorganic particles include at least one kind selected from the group consisting of alumina, silica, zirconia, titania, ceria, mullite and zeolite.

In the method for manufacturing a honeycomb structure according to the embodiment of the first invention, at least one of the inorganic fibers and whiskers include at least one kind selected from the group consisting of alumina, silica, silicon carbide, silica-alumina, glass, potassium titanate and aluminum borate.

In the method for manufacturing a honeycomb structure according to the embodiment of the first invention, the inorganic binder includes at least one kind selected from the group consisting of alumina sol, silica sol, titania sol, water glass, sepiolite and attapulgite.

Use of a raw material composition containing these substances as described above makes it easier to manufacture a honeycomb structure having a high specific surface area and high strength.

Thus, the honeycomb structure having a high specific surface area and high strength is desirably used as a catalyst supporting carrier.

The method for manufacturing a honeycomb structure according to one embodiment of the second invention includes: molding a raw material composition to manufacture a honeycomb molded body having a large number of cells longitudinally placed substantially in parallel with one another with a cell wall interposed therebetween; firing the honeycomb molded body to manufacture a honeycomb fired body; forming a water repellent layer on a side face of the honeycomb fired body; and bonding a plurality of the honeycomb fired bodies to one another by using an adhesive paste and forming an adhesive layer to manufacture a honeycomb aggregated body.

In the method for manufacturing a honeycomb structure according to the embodiment of the second invention, the bonding process is carried out after the water repellent layer has been formed on the side face of the honeycomb fired body.

With reference to the figure, the following description will discuss effects of the method in which the water repellent layer is formed on a side face of a honeycomb fired body.

FIG. 4 is a cross-sectional view that schematically shows the neighborhood of a side face of a honeycomb fired body, upon filling with an adhesive paste after formation of a water repellent layer on the side face of the honeycomb fired body in the method for manufacturing a honeycomb structure according to the embodiment of the second invention.

In FIG. 4, the water repellent layer 30 is indicated by slanting lines, and arrows indicate moisture being repelled by the water repellent layer 30.

The water repellent layer 30 is a layer having such a property that it repels the water upon contact with water. For this reason, when the moisture 10 contained in the adhesive paste 120 makes contact with the water repellent layer 30, the moisture 10 is repelled by the surface of the water repellent layer 30, and consequently tends to be prevented from moving into the honeycomb fired body 110 located ahead of the water repellent layer 30 (downward in FIG. 4).

Moreover, the moisture 10 having contact with the water repellent layer 30 tends not to be allowed to move into the inside of the water repellent layer 30.

For this reason, when the water repellent layer 30 is formed on the side faces of the honeycomb fired body 110, the moisture 10 contained in the adhesive paste 120 is unlikely to move into the honeycomb fired body 110.

In the case of filling with the adhesive paste 120 after the formation of the water repellent layer 30 on the side face of the honeycomb fired body 110, the amount of moisture contained in the adhesive paste 120 hardly decreases, even when the gap 420 between the honeycomb fired bodies is filled with the adhesive paste 120 toward the right side of FIG. 4.

Therefore, in FIG. 4, the dots indicating the moisture 10 are distributed virtually uniformly from the left side to the right side of the adhesive paste 120.

For this reason, it may become easier to fill up to the neighborhood of the end face of the honeycomb fired body with the adhesive paste while keeping the low viscosity and the high flowability of the adhesive paste.

Therefore, filling with the adhesive paste tends to be carried out by applying low pressure to the adhesive paste. Additionally, the adhesive paste layer tends to be formed with high working efficiency without necessity of separate filling with the adhesive paste from the end face of the honeycomb fired body.

In the method for manufacturing a honeycomb structure according to the embodiment of the second invention, a water repellent agent is applied to a side face of the honeycomb fired body to form the water repellent layer.

The application of the water repellent agent to the side face of the honeycomb fired body tends to facilitate the formation of the water repellent layer on the side face of the honeycomb fired body.

In the method for manufacturing a honeycomb structure according to the embodiment of the second invention, the water repellent agent includes silicone oil, wax, or glass.

Since these components have a water repellent property, use of any of these components makes it easier to form the water repellent layer on the side face of the honeycomb fired body, and thereby to prevent the moisture contained in the adhesive paste from being absorbed into the honeycomb fired body.

In the method for manufacturing a honeycomb structure according to the embodiment of the second invention, the raw material composition includes inorganic particles, at least one of inorganic fibers and whiskers, and an inorganic binder.

In the method for manufacturing a honeycomb structure according to the embodiment of the second invention, the inorganic particles include at least one kind selected from the group consisting of alumina, silica, zirconia, titania, ceria, mullite and zeolite.

In the method for manufacturing a honeycomb structure according to the embodiment of the second invention, at least one of the inorganic fibers and whiskers include at least one kind selected from the group consisting of alumina, silica, silicon carbide, silica-alumina, glass, potassium titanate and aluminum borate.

In the method for manufacturing a honeycomb structure according to the embodiment of the second invention, the inorganic binder includes at least one kind selected from the group consisting of alumina sol, silica sol, titania sol, water glass, sepiolite and attapulgite.

Use of the raw material composition containing these substances as described above makes it easier to manufacture a honeycomb structure having a high specific surface area and high strength.

Moreover, the honeycomb structure having a high specific surface area and high strength can be desirably used as a catalyst supporting carrier.

The method for manufacturing a honeycomb structure according to one embodiment of the third invention includes: molding a raw material composition to manufacture a honeycomb molded body having a large number of cells longitudinally placed substantially in parallel with one another with a cell wall interposed therebetween; firing the honeycomb molded body to manufacture a honeycomb fired body; forming a base adhesive paste layer having a large moisture content on a side face of the honeycomb fired body; and bonding a plurality of the honeycomb fired bodies to one another by using an adhesive paste and forming an adhesive layer to manufacture a honeycomb aggregated body.

In the method for manufacturing a honeycomb structure according to the embodiment of the third invention, prior to the bonding process, a base adhesive paste layer forming process is carried out to form a base adhesive paste layer having a higher moisture content on the side face of the honeycomb fired body.

Here, “the base adhesive paste layer having a higher moisture content” refers to “an adhesive paste layer having a higher moisture content (% by weight) than that of an adhesive paste to be used in the bonding process.”

With reference to the figure, the following description will discuss the effects generated by forming a base adhesive paste layer on the side face of the honeycomb fired body.

FIG. 5 is a cross-sectional view that schematically shows a neighborhood of a side face of a honeycomb fired body upon filling with an adhesive paste after formation of a base adhesive paste layer on the side face of the honeycomb fired body in the method for manufacturing a honeycomb structure according to the embodiment of the third invention.

In FIG. 5, the base adhesive paste layer 40 is indicated by slanting lines.

In addition, arrows indicate directions of the moisture 10 to move from the base adhesive paste layer 40 to the honeycomb fired body 110 and the adhesive paste 120.

Here, the base adhesive paste layer 40 contains more moisture 10 than the adhesive paste 120.

In this case, since the adhesive paste 120 does not directly make contact with the honeycomb fired body 110, the moisture 10 contained in the adhesive paste 120 tends not to be directly absorbed into the honeycomb fired body 110.

Moreover, the base adhesive paste layer 40 is a layer that contains more moisture 10 than the adhesive paste 120. Consequently, when the adhesive paste 120 and the base adhesive paste layer 40 make contact with each other, less amount of moisture 10 moves from the adhesive paste 120 toward the base adhesive paste layer 40 in contrast to more amount of moisture 10 to move from the base adhesive paste layer 40 toward the adhesive paste 120.

Here, moisture also moves from the base adhesive paste layer 40 to the honeycomb fired body 110.

Therefore, in the case of filling with the adhesive paste 120 after the formation of the base adhesive paste layer 40 on the side face of the honeycomb fired body 110, the amount of moisture contained in the adhesive paste 120 hardly decreases, even when the gap 420 between the honeycomb fired bodies is filled with the adhesive paste 120 toward the right side of FIG. 5.

Therefore, in FIG. 5, the dots indicating the moisture 10 are distributed virtually uniformly from the left side toward the right side of the adhesive paste 120.

For this reason, it may become easier to fill up to the neighborhood of the end face of the honeycomb fired body with the adhesive paste while keeping the low viscosity and the high flowability of the adhesive paste.

Therefore, filling with the adhesive paste tends to be carried out by applying low pressure to the adhesive paste. Additionally, the adhesive paste layer tends to be formed with high working efficiency without necessity of separate filling with the adhesive paste from the end face of the honeycomb fired body.

In the method for manufacturing a honeycomb structure according to the embodiment of the third invention, moisture is added to the adhesive paste used in the bonding to prepare a base adhesive paste serving as a material for the base adhesive paste layer.

Since the adhesive paste to be used in the bonding process and the base adhesive paste are different from each other only in their moisture contents, the adhesive layers having the same composition can be formed by drying these two kinds of adhesive pastes. When the adhesive layers to be formed have the same composition, no border is substantively formed in the honeycomb structure. Therefore, when such a honeycomb structure is used as a catalyst supporting carrier, the resulting adhesive layer tends to eliminate peeling and the like between the adhesive layers.

In the method for manufacturing a honeycomb structure according to the embodiment of the third invention, the base adhesive paste is applied to each side face of the honeycomb fired body to form the base adhesive paste layer.

The application of the base adhesive paste to the side face of honeycomb fired body tends to facilitate the formation of the base adhesive paste layer on the side face of the honeycomb fired body.

In the method for manufacturing a honeycomb structure according to the embodiment of the third invention, the raw material composition includes inorganic particles, at least one of inorganic fibers and whiskers, and an inorganic binder.

In the method for manufacturing a honeycomb structure according to the embodiment of the third invention, the inorganic particles include at least one kind selected from the group consisting of alumina, silica, zirconia, titania, ceria, mullite and zeolite.

In the method for manufacturing a honeycomb structure according to the embodiment of the third invention, at least one of the inorganic fibers and whiskers include at least one kind selected from the group consisting of alumina, silica, silicon carbide, silica-alumina, glass, potassium titanate and aluminum borate.

In the method for manufacturing a honeycomb structure according to the embodiment of the third invention, the inorganic binder includes at least one kind selected from the group consisting of alumina sol, silica sol, titania sol, water glass, sepiolite and attapulgite.

Use of the raw material composition containing these substances as described above makes it easier to manufacture a honeycomb structure having a high specific surface area and high strength.

Moreover, the honeycomb structure having a high specific surface area and high strength can be desirably used as a catalyst supporting carrier.

### First Embodiment

The following description will discuss a first embodiment that is one embodiment of the method for manufacturing a honeycomb structure according to the first invention.

First, with reference to the figures, the following description will describe the honeycomb structure manufactured by the method for manufacturing a honeycomb structure according to the embodiment of the first invention.

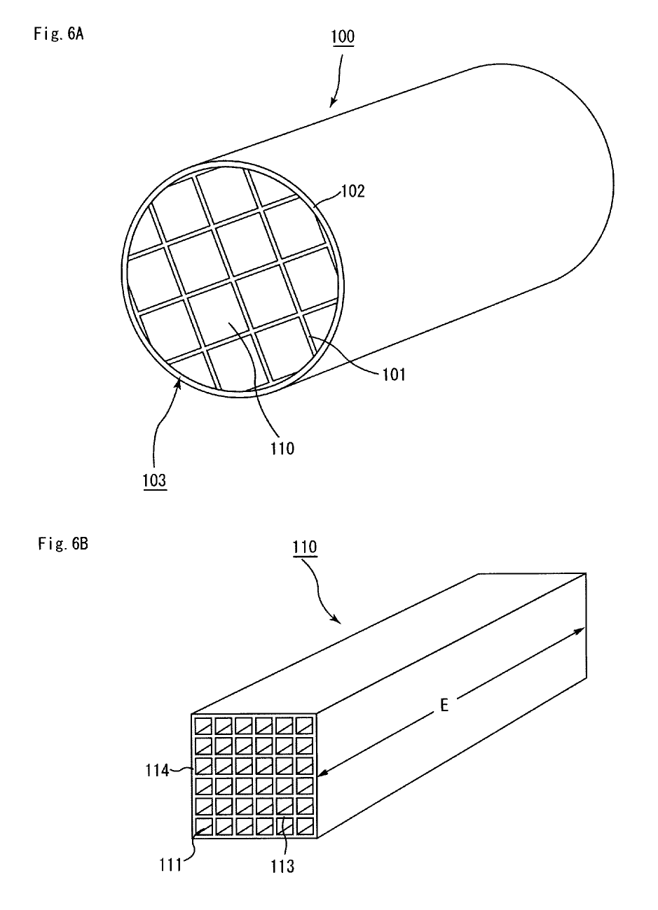

FIG. 6A is a perspective view schematically showing one example of a honeycomb structure manufactured by the method for manufacturing a honeycomb structure according to the embodiment of the first invention, and FIG. 6B is a perspective view schematically showing one example of a honeycomb fired body.

In a honeycomb structure 100 shown in FIG. 6A, a plurality of square pillar-shaped honeycomb fired bodies 110 which includes a porous ceramic shown in FIG. 6B, are combined with one another by interposing an adhesive layer 101 to form a ceramic block 103, with a coat layer 102 formed on the periphery of the ceramic block 103.

In the honeycomb fired body 110 shown in FIG. 6B, a large number of cells 111 are aligned side by side in the longitudinal direction (in a direction indicated by an arrow E in FIG. 6B) with a cell wall 113 interposed therebetween.

Here, an outer wall 114 is formed on the outermost periphery of the honeycomb fired body 110.

A fluid such as exhaust gases is allowed to flow through the cells 111, and a catalyst used for converting the exhaust gases can be supported on the cell wall 113 and the outer wall 114. Therefore, when the exhaust gases are allowed to flow through the cells 111 with the catalyst supported on the cell wall 113 and the outer wall 114, toxic components contained in the exhaust gases flowing through the cells 111 are converted by functions of the catalyst supported thereon.

The following description will discuss a method for manufacturing such a honeycomb structure according to the embodiment of the first invention by using a water retention adhesive paste containing a water retention agent.

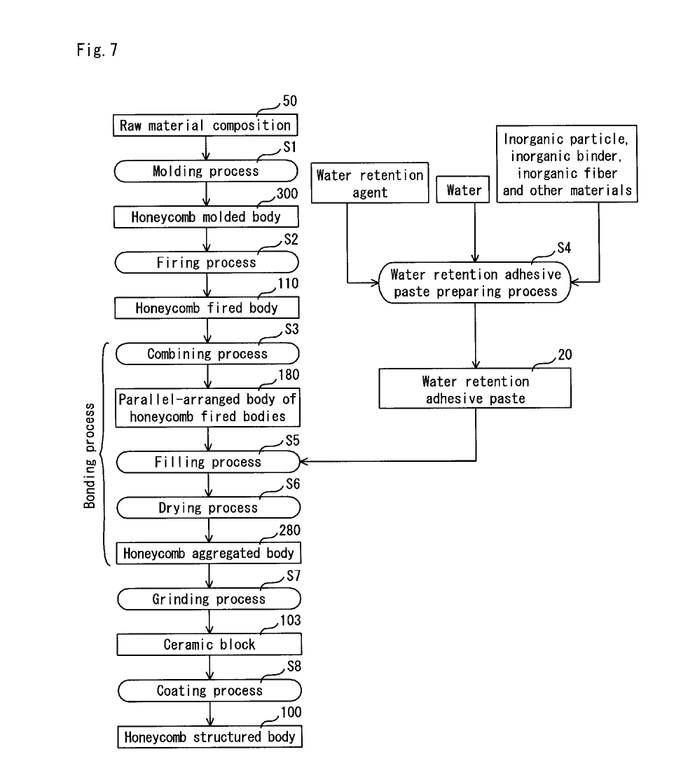

FIG. 7 is a flow chart that illustrates main processes of the method for manufacturing a honeycomb structure according to the embodiment of the first invention in which a honeycomb structure is manufactured by using the water retention adhesive paste containing the water retention agent.

First, a molding process S1 is carried out to manufacture a honeycomb molded body 300 by molding a raw material composition 50.

In the molding process S1, the raw material composition 50 containing inorganic particles such as alumina is extruded from a die by using an extrusion molding machine to manufacture a honeycomb molded body having virtually the same shape as that of a honeycomb fired body to be manufactured.

The raw material composition 50 is a mixture which contains inorganic particles, at least one of inorganic fibers and whiskers, and an inorganic binder, and to which an organic binder, a dispersant and a forming auxiliary are further added on demand depending on the moldability.

Moreover, if necessary, processes such as a cutting process, a drying process and a degreasing process are carried out on the manufactured honeycomb molded body 300.

In the drying process of the honeycomb molded body, a microwave drying apparatus, a hot-air drying apparatus, a dielectric drying apparatus, a reduced-pressure drying apparatus, a vacuum drying apparatus, a freeze drier or the like may be used.

Moreover, although not particularly limited, degreasing conditions in the degreasing process are selected on demand depending on kinds and amounts of organic components contained in the molded body, and preferably set to about 400° C. for about two hours.

Successively, a firing process S2 is carried out. In the firing process S2, the honeycomb molded body 300 is fired in a firing furnace to manufacture a honeycomb fired body 110. Although not particularly limited, the firing conditions are preferably at least about 500° C. and at most about 1200° C., more preferably at least about 600° C. and at most about 1000° C.

By carrying out these processes, a pillar-shaped honeycomb fired body having a large number of cells longitudinally placed substantially in parallel with one another with a cell wall therebetween can be manufactured.

Here, in the present specification, “the pillar shape” includes a desired pillar shape, such as a cylindrical shape, a cylindroid shape and a polygonal pillar shape.

Next, a combining process S3 is carried out. The combining process S3 is a process to manufacture a parallel-arranged body 180 of honeycomb fired bodies having a predetermined shape by combining a plurality of honeycomb fired bodies 110 with one another with a spacer interposed therebetween.

In this combining process, by using the spacer having the same thickness as the thickness of the adhesive layer to be formed, a gap having the same width as the thickness of the spacer is formed between the side faces of the respective honeycomb fired bodies 110.

Although not particularly limited, examples of the material for the spacer preferably include cardboard, fibrous paper, inorganic material sheet and the like.

Prior to the next filling process S5, a water retention adhesive paste preparing process S4 is carried out to prepare a water retention adhesive paste 20 to be used in the filling process S5.

In the water retention adhesive paste preparing process S4, the water retention adhesive paste 20 is prepared by mixing and kneading a water retention agent, water, inorganic particles, at least one of inorganic fibers and whiskers, an inorganic binder and other materials.

Although not particularly limited as long as the water retention agent can prevent moisture in the adhesive paste from being absorbed into the honeycomb fired body, examples thereof include a water absorbing polymer, a high porosity adhesive, montmorillonite, vermiculite, saponite and the like.

Examples of the water absorbing polymer include sodium polyacrylate and the like.

Next, the filling process S5 is carried out by using the prepared water retention adhesive paste 20.

In the filling process S5, the parallel-arranged body 180 of honeycomb fired bodies manufactured in the combining process S3 is placed in a filling apparatus as shown in FIGS. 1A and 1B, and the water retention adhesive paste 20 is charged into the paste chamber of the filling apparatus.

Then, by using the extruding mechanism of the filling apparatus, the water retention adhesive paste 20 is filled into the gap formed in the parallel-arranged body 180 of honeycomb fired bodies.

At this time, since the moisture contained in the water retention adhesive paste is hardly absorbed into the honeycomb fired bodies, the gap is filled with the water retention adhesive paste up to the neighborhood of the end face of the honeycomb fired body while keeping the low viscosity and high flowability of the water retention adhesive paste.

Next, a drying process S6 is carried out on the parallel-arranged body of honeycomb fired bodies filled with the water retention adhesive paste. In the drying process S6, the water retention adhesive paste is dried and solidified to be formed into an adhesive layer; thus, the honeycomb fired bodies are bonded to one another with the adhesive layer interposed therebetween.

Although not particularly limited, the drying conditions are preferably set to heating at a temperature of at least about 50° C. and at most about 150° C. for about one hour.

Here, a series of processes in which the honeycomb fired bodies are bonded to one another, including the combining process, the filling process and the drying process, are collectively defined as a bonding process.

By carrying out the bonding process, a honeycomb aggregated body 280 having a plurality of honeycomb fired bodies bonded to one another with an adhesive layer interposed therebetween can be manufactured.

Hereinafter, a cutting process S7 is carried out to manufacture a ceramic block 103 by cutting the periphery of the manufactured honeycomb aggregated body into a predetermined shape such as a cylindrical shape.

Moreover, a coating process S8 is carried out to form a coat layer on the periphery of the ceramic block 103 by applying a sealing material paste to the outer peripheral face of the ceramic block 103, then drying and solidifying the sealing material paste.

Here, it is not necessarily required to carry out the cutting process S7 and the coating process S8, and these processes may be carried out on demand.

The following description will summarize the effects of the method for manufacturing a honeycomb structure of the present embodiment.

(1) In the method for manufacturing a honeycomb structure of the present embodiment, an adhesive paste containing a water retention agent is prepared, and a bonding process is carried out by using the adhesive paste containing the water retention agent.

Much moisture is contained in the water retention adhesive paste. Since the moisture having contact with the water retention agent is hardly allowed to move to another portion, the moisture contained in the water retention adhesive paste is hardly allowed to move to another portion from the water retention adhesive paste. Consequently, even when the water retention adhesive paste and the honeycomb fired body make contact with each other, the moisture contained in the water retention adhesive paste is hardly absorbed into the honeycomb fired body. Therefore, even in the process in which the gap between the honeycomb fired bodies is filled with the water retention adhesive paste, the amount of moisture contained in the water retention adhesive paste hardly decreases. For this reason, it may become easier to fill up to the neighborhood of the end face of the honeycomb fired body with the water retention adhesive paste while keeping the low viscosity and high flowability of the water retention adhesive paste.

Therefore, filling with the water retention adhesive paste tends to be carried out by applying low pressure to the water retention adhesive paste. Additionally, the adhesive paste layer tends to be formed with high working efficiency without necessity of separate filling with the adhesive paste from the end face of the honeycomb fired body.

(2) In the method for manufacturing a honeycomb structure of the present embodiment, the water retention agent includes a water absorbing polymer, a high porosity adhesive, montmorillonite, vermiculite or saponite.

The water retention adhesive paste containing any of these components makes it easier to prevent the moisture in the water retention adhesive paste from being absorbed into the honeycomb fired body, due to the water retention property of these components.

(3) In the honeycomb structure of the present embodiment, the raw material composition contains inorganic particles, at least one of inorganic fibers and whiskers, and an inorganic binder. Use of the raw material composition containing these components makes it easier to manufacture a honeycomb structure having a high specific surface area and high strength.

The honeycomb structure having a high specific surface area and high strength can be desirably used as a catalyst supporting carrier.

The following description will discuss Examples that more specifically disclose the first embodiment of the first invention. Here, the first invention is not intended to be limited only by these Examples.

In the present Examples and Comparative Examples, a honeycomb fired body was manufactured, and an adhesive paste layer was applied to the side face of the honeycomb fired body so that the amount of moisture (water absorbing ratio) absorbed into the honeycomb fired body was measured. Moreover, in the bonding process, filling with the adhesive paste was carried out with a predetermined load being applied to the adhesive paste, so that the degree of filling with the adhesive paste was observed.

### EXAMPLE 1

### (Process for Manufacturing Honeycomb Fired Body)

An amount of 2250 g of γ-alumina particles (average particle diameter: 2 μm), 680 g of aluminum borate whiskers (average fiber diameter: 0.5 to 1 μm, average fiber length: 10 to 30 μm) and 2600 g of silica sol (solid concentration: 30% by weight) were mixed. To the obtained mixture were added 320 g of methyl cellulose as the organic binder, 290 g of a lubricant (UNILUB, manufactured by NOF Corporation) and 225 g of a plasticizer (glycerin), and the resulting mixture was further mixed and kneaded to obtain a raw material composition. Next, this raw material composition was extrusion-molded by using an extrusion molding machine to obtain a raw honeycomb molded body.

Next, the raw honeycomb molded body was sufficiently dried by using a microwave drying apparatus and a hot air drying apparatus, and then maintained at a temperature of 400° C. for two hours to be degreased to obtain a honeycomb degreased body.

Thereafter, the honeycomb degreased body was maintained at a temperature of 800° C. for two hours to be fired so that a rectangular pillar-shaped honeycomb fired body (37 mm×37 mm×150 mm) having a cell density of 93 pcs/cm² (600 cpsi), a thickness of the cell wall of 0.2 mm and a tetragonal shape (square) in the cross-sectional shape of each cell was obtained.

### (Process for Preparing Water Retention Adhesive Paste)

An amount of 29% by weight of γ-alumina particles (average particle diameter: 2 μm), 7% by weight of aluminum borate whiskers (average fiber diameter: 0.5 to 1 μm, average fiber length: 10 to 30 μm), 34% by weight of silica sol (solid concentration: 30% by weight), 5% by weight of carboxy methylcellulose (CMC) and 25% by weight of water were mixed to prepare an adhesive paste. Additionally, with respect to 100 parts by weight of the adhesive paste, 0.2 parts by weight of sodium polyacrylate was added as a water retention agent to prepare a water retention adhesive paste.

### (Measurement of Weight Increasing Ratio of Honeycomb Fired Body Due to Water Absorption)

After measurement of the weight of the manufactured honeycomb fired body, the prepared water retention adhesive paste was applied to one side face (upper face) of the honeycomb fired body so as to have a thickness of 1 mm, and left to stand for 30 seconds.

Thereafter, the applied water retention adhesive paste was scraped from the side face of the honeycomb fired body by using a scraper, and the weight of the honeycomb fired body was measured again.

Thus, a weight change of the honeycomb fired body before and after the application of the adhesive paste was measured. On the supposition that the increased weight of the honeycomb fired body corresponds to moisture absorbed from the adhesive paste, the weight increasing ratio (%) of the honeycomb fired body due to the water absorption was calculated by the following equation.

The weight increasing ratio (%) of the honeycomb fired body due to water absorption=[(the weight of the honeycomb fired body after the application of the adhesive paste−the weight of the honeycomb fired body before the application of the adhesive paste)/the weight of the honeycomb fired body before the application of the adhesive paste]×100

Table 1 shows the results of the calculations.

TABLE 1

| | | Weight increasing ratio (%) of | |
|---|---|---|---|
| | Water retention | honeycomb fired body due to | Filling |
| | agent | water absorption | property |
| Example 1 | Sodium | 1.0 | Good |
| | polyacrylate | | |
| Example 2 | Montmorillonite | 0.8 | Good |
| Example 3 | Vermiculite | 1.1 | Good |
| Example 4 | Saponite | 1.0 | Good |
| Comparative | None | 3.5 | Bad |
| Example 1 | | | |

### (Observation of Filling Property)

Sixteen honeycomb fired bodies (not including the honeycomb fired body used for the measurement of the weight increasing ratio) were stacked four by four vertically as well as horizontally with a spacer interposed therebetween so as to manufacture a parallel-arranged body of honeycomb fired bodies.

Next, the parallel-arranged body of honeycomb fired bodies was placed inside a filling apparatus, and a water retention adhesive paste was charged into the paste chamber of the filling apparatus.

Pressure of 1.3 kgf/cm² (0.13 MPa) was applied onto the water retention adhesive paste by using an extruding mechanism, in attempting to fill the gap formed in the parallel-arranged body of honeycomb fired bodies with the water retention adhesive paste.

Then, the gap was smoothly filled with the water retention adhesive paste, and the water retention adhesive paste had reached the end face of each honeycomb fired body.

That is, in the present Example, it was possible to fill with the water retention paste with high working efficiency, and the filling property of the adhesive paste was good.

### EXAMPLES 2 TO 4

The measurements of the weight increasing ratio and the observation of the filling property were carried out by following the same processes as in Example 1 except that in the process for preparing the water retention adhesive paste, each of substances (0.2 parts by weight) shown in Table 1 was added as a water retention agent relative to 100 parts by weight of the adhesive paste to prepare a water retention adhesive paste.

Table 1 shows the results.

### COMPARATIVE EXAMPLE 1

The measurements of the weight increasing ratio and the observation of the filling property were carried out by following the same processes as in Example 1 except that no water retention agent was added to the adhesive paste. Table 1 shows the results.

Comparing the results of respective Examples and Comparative Example shown in Table 1, the weight increasing ratios of the honeycomb fired bodies of respective Examples due to water absorption are relatively lower than that in Comparative Example 1, thus indicating that moisture in the adhesive paste is hardly absorbed into the honeycomb fired body.

Moreover, the filling properties were good in the respective Examples; in contrast, in Comparative Example 1, the flowability of the adhesive paste deteriorated in the middle of the filling process, failing to fill with the adhesive paste up to the end face of the honeycomb fired body. That is, Comparative Example 1 was probably bad in the filling property.

The above-mentioned results show that use of the water retention adhesive paste containing the water retention agent makes it easier to prevent moisture in the adhesive paste from being absorbed into the honeycomb fired body, and consequently to fill with the adhesive paste with high working efficiency.

### Second Embodiment

The following description will discuss a second embodiment that is one embodiment of the method for manufacturing a honeycomb structure according to the second invention.

In the present embodiment, a bonding process is carried out with formation of a water repellent layer on a side face of a honeycomb fired body.

Here, an adhesive paste having no water retention agent is used as the adhesive paste.

Since a honeycomb structure to be manufactured in the present embodiment has the same structure as that of the honeycomb structure manufactured in the method for manufacturing a honeycomb structure in the first embodiment, the detailed description of the honeycomb structure body is omitted.

The following description will discuss a method for manufacturing a honeycomb structure according to the embodiment of the second invention, in which a water repellent layer is formed on a side face of a honeycomb fired body to manufacture the honeycomb structure.

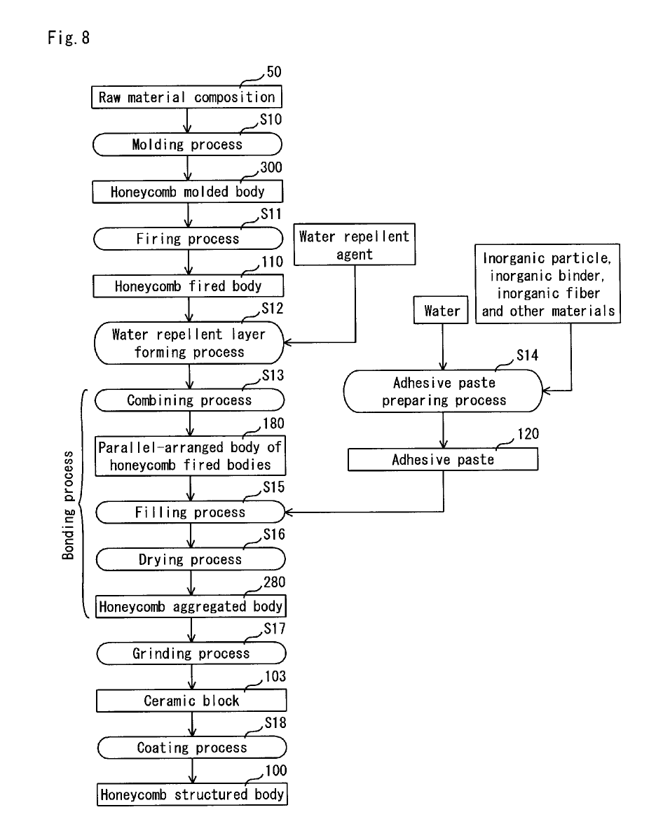

FIG. 8 is a flow chart that illustrates main processes of the method for manufacturing a honeycomb structure according to the embodiment of the second invention, in which the water repellent layer is formed on the side face of the honeycomb fired body.

First, by following the same processes as in the method for manufacturing a honeycomb structure of the first embodiment, a molding process S10 and a firing process S11 are carried out to manufacture the honeycomb fired body 110.

Next, a water repellent layer forming process S12 is carried out to form the water repellent layer on the side face of the honeycomb fired body 110.

In the water repellent layer forming process S12, a water repellent agent is applied to the side face of the honeycomb fired body 110 to form the repellent layer on the side faces of the honeycomb fired body. Although the water repellent agent is not particularly limited as long as it exerts a water repellent property upon contact with water, examples thereof include silicone oil, wax, glass and the like.

When silicone oil in the form of a liquid is used, the silicone oil, as it is, may be applied to the side face of the honeycomb fired body to form the water repellent layer on the side face of the honeycomb fired body.

When wax is used, wax may be rubbed onto the side face of the honeycomb fired body, or may be heated into a liquid, and then applied thereon to form the water repellent layer.

When glass is used, a glass coating agent containing a SiO₂ component is applied and dried to form the water repellent layer.

Next, a combining process S13 is carried out by following the method for manufacturing the honeycomb structure of the first embodiment using the honeycomb fired body with water repellent layer formed on the side face thereof to manufacture a parallel-arranged body 180 of the honeycomb fired bodies.

Successively, prior to a filling process S15, an adhesive paste preparing process S14 is carried out.

The same adhesive paste as that used in the method for manufacturing a honeycomb structure of the first embodiment except that it contains no water retention agent may be used as the adhesive paste 120 to be prepared in the adhesive paste preparing process S14.

Thereafter, the filling process S15 and the drying process S16 are carried out by following the same processes as in the method for manufacturing a honeycomb structure of the first embodiment to manufacture a honeycomb aggregated body 280. Moreover, a cutting process S17 is carried out on demand to form a ceramic block 103, and a coating process S18 is carried out thereon to manufacture a honeycomb structure 100.

The following description will summarize the effects of the method for manufacturing a honeycomb structure of the present embodiment.

In addition to the effect (3) described in the first embodiment, the present embodiment makes it possible to exert the following effects.

(4) In the method for manufacturing a honeycomb structure of the present embodiment, after formation of the water repellent layer on the side face of each honeycomb fired body, the bonding process is carried out on the honeycomb fired bodies.

The water repellent layer is a layer having such a property that it repels the water upon contact with water. For this reason, when moisture contained in the adhesive paste makes contact with the water repellent layer, the moisture is repelled by the surface of the water repellent layer, and consequently tends to be prevented from moving into the honeycomb fired body located ahead of the water repellent layer.

Moreover, the moisture having contact with the water repellent layer also tends not to be allowed to move into the inside of the water repellent layer.

For this reason, when the water repellent layer is formed on the side face of the honeycomb fired body, the moisture contained in the adhesive paste is unlikely to move into the honeycomb fired body.

Here, in the case of filling with the adhesive paste after the formation of the water repellent layer on the side face of the honeycomb fired body, the amount of moisture contained in the adhesive paste hardly decreases, during the filling process of the gap the honeycomb fired bodies with the adhesive paste. For this reason, it may become easier to fill up to the neighborhood of the end face of the honeycomb fired body with the adhesive paste while keeping the low viscosity and high flowability of the adhesive paste.

Therefore, filling with the adhesive paste tends to be carried out by applying low pressure to the adhesive paste. Additionally, the adhesive paste layer tends to be formed with high working efficiency without necessity of separate filling with the adhesive paste from the end face of the honeycomb fired body.

(5) In the method for manufacturing a honeycomb structure of the present embodiment, the water repellent agent includes any of silicone oil, wax or glass.

Since these substances have a water repellent property, use of any of these components makes it easier to form the water repellent layer on the side face of the honeycomb fired body, and thereby to prevent the moisture contained in the adhesive paste from being absorbed into the honeycomb fired body.

The following description will discuss Examples that more specifically disclose the second embodiment of the second invention. Here, the second invention is not intended to be limited only by these Examples.

In the present Examples, measurements of the water absorbing ratio and observation of the filling property of the adhesive paste were carried out by following the same processes as in the Examples of the method for manufacturing a honeycomb structural body of the first embodiment.

### EXAMPLE 5

Honeycomb fired bodies were manufactured by following the same processes as in Example 1.

A water repellent layer forming process was carried out to form a water repellent layer on the side face of the honeycomb fired body by applying silicone oil serving as a water repellent agent to the side face of the honeycomb fired body.

Here, an adhesive paste prior to the addition of a water retention agent prepared in Example 1 (the same adhesive paste used in Comparative Example 1) was prepared as the adhesive paste.

The measurements of the weight increasing ratio and the observation of the filling property were carried out by following the same processes as in Example 1 using the honeycomb fired body with the water repellent layer formed thereon and the adhesive paste.

Table 2 shows the results.

TABLE 2

| | | Weight increasing ratio (%) of | |
|---|---|---|---|
| | Water repellent | honeycomb fired body due to | Filling |
| | agent | water absorption | property |
| Example 5 | Silicone oil | 0.1 | Good |
| Example 6 | Wax | 0.1 | Good |
| Example 7 | Glass | 0.1 | Good |
| Comparative | None | 3.5 | Bad |
| Example 1 | | | |

### EXAMPLE 6

The measurements on the weight increasing ratio and the observation of the filling property were carried out by following the same processes as in Example 5 except that wax was used as the water repellent agent. Table 2 shows the results.

Here, the water repellent layer was formed by heating wax into a liquid and then applying the wax to the side face of the honeycomb fired body.

### EXAMPLE 7

The measurements of the weight increasing ratio and the observation of the filling property were carried out by following the same processes as in Example 5 except that glass was used as the water repellent agent. Table 2 shows the results.

Here, the water repellent layer was formed by applying a glass coating agent containing SiO₂ to the side face of the honeycomb fired body and drying the glass coating agent.

Comparing the results of the respective Examples and Comparative Example shown in Table 2, the weight increasing ratios of the honeycomb fired bodies of the respective Examples due to water absorption are relatively lower than that in Comparative Example 1, with the result that moisture in the adhesive paste is hardly absorbed into the honeycomb fired body.

Moreover, the filling properties are good in the respective Examples; in contrast, in Comparative Example 1, the flowability of the adhesive paste decreased in the middle of the filling process, failing to fill up to the end face of the honeycomb fired body with the adhesive paste. That is, Comparative Example 1 is probably insufficient in the filling property.

The above-mentioned results clearly show that formation of the water repellent layer on the side face of the honeycomb fired body makes it easier to prevent moisture in the adhesive paste from being absorbed into the honeycomb fired body, and consequently to fill with the adhesive paste with high working efficiency.

### Third Embodiment

The following description will discuss a third embodiment that is one embodiment of the method for manufacturing a honeycomb structure according to the third invention.

In the present embodiment, the bonding process is carried out by forming a base adhesive paste layer on a side face of a honeycomb fired body.

Here, an adhesive paste, which contains no water retention agent and has a moisture content higher than that of the adhesive paste used for filling a gap between the honeycomb fired bodies, is used as the base adhesive paste.

Further, since a honeycomb structure to be manufactured in the present embodiment has the same structure as that of the honeycomb structure manufactured in the method for manufacturing the honeycomb structure in the first embodiment, the detailed description of the honeycomb structure is omitted.

The following description will discuss a method for manufacturing a honeycomb structure according to the embodiment of the third invention in which a base adhesive paste layer is formed on a side face of a honeycomb fired body.

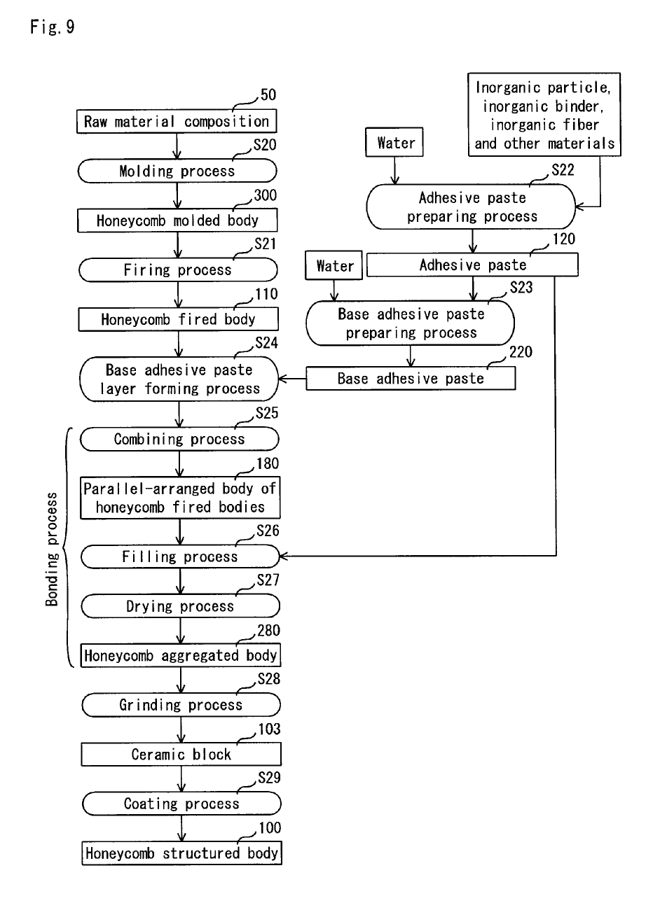

FIG. 9 is a flow chart that illustrates main processes of the method for manufacturing a honeycomb structure according to the embodiment of the third invention in which a base adhesive paste layer is formed on a side face of a honeycomb fired body.

First, by following the same processes as in the method for manufacturing a honeycomb structure of the first embodiment, a molding process S20 and a firing process S21 are carried out to manufacture a honeycomb fired body 110.

Next, prior to a base adhesive paste layer forming process S24 in which a water repellent layer is formed on the side face of the honeycomb fired body 110, an adhesive paste preparing process S22 and a base adhesive paste preparing process S23 are carried out.

In the adhesive paste preparing process S22, an adhesive paste 120 is prepared by following the same processes as in the method for manufacturing a honeycomb structure of the second embodiment.

Then, in the base adhesive paste preparing process S23, water is further added to the adhesive paste 120 and kneaded to prepare a base adhesive paste 220 having a moisture content higher than that of the adhesive paste 120.

In the base adhesive paste layer forming process S24, the base adhesive paste layer is formed on the side face of the honeycomb fired body by applying the base adhesive paste 220 to the side face of the honeycomb fired body 110.

Here, the base adhesive paste layer is formed on each side face of the honeycomb fired bodies except the side faces serving as a peripheral face in a parallel-arranged body of honeycomb fired bodies to be manufactured.

Next, by using the honeycomb fired body with the base adhesive paste layer formed on the side face thereof, a combining process S25 is carried out by following the same processes as in the method for manufacturing a honeycomb structure of the first embodiment to manufacture a parallel-arranged body 180 of the honeycomb fired bodies.

Successively, a filling process S26 is carried out by following the same manner as in the method for manufacturing a honeycomb structure of the first embodiment to fill the gap between the honeycomb fired bodies with the adhesive paste by using the adhesive paste 120 prepared in the adhesive paste preparing process S22.

Hereinafter, a drying process S27 is carried out by following the same processes as in the method for manufacturing a honeycomb structure of the first embodiment to manufacture a honeycomb aggregated body 280. Moreover, a cutting process S28 is carried out thereon, if necessary, to form a ceramic block 103, and a coating process S29 is carried out thereon to manufacture a honeycomb structure 100.

The following description will summarize the effects of the method for manufacturing a honeycomb structure of the present embodiment.

In addition to the effect (3) described in the first embodiment, the present embodiment makes it possible to exert the following effects.

(6) In the method for manufacturing a honeycomb structure of the present embodiment, after formation of the base adhesive paste layer on the side face of each honeycomb fired body, the bonding process is carried out on the honeycomb fired bodies.

When the base adhesive paste layer is formed, since the adhesive paste does not directly make contact with the honeycomb fired bodies, moisture contained in the adhesive paste tends to be prevented from being directly absorbed into the honeycomb fired bodies.

Moreover, the base adhesive paste layer is a layer that contains more moisture than the adhesive paste. For this reason, when the adhesive paste and the base adhesive paste layer make contact with each other, less amount of moisture moves from the adhesive paste toward the base adhesive paste layer in contrast to more amount of moisture to move from the base adhesive paste layer toward the adhesive paste.

Therefore, in the case of filling with the adhesive paste after the formation of the base adhesive layer on the side face of the honeycomb fired body, the amount of moisture contained in the adhesive paste hardly decreases in the process for filling the gap between the honeycomb fired bodies with the adhesive paste. For this reason, it may become easier to fill up to the neighborhood of the end face of the honeycomb fired body with the adhesive paste while keeping the low viscosity and the high flowability of the adhesive paste.

Therefore, filling with the adhesive paste tends to be carried out by applying low pressure to the adhesive paste. Additionally, the adhesive paste layer tends to be formed with high working efficiency without necessity of separate filling with the adhesive paste from the end face of the honeycomb fired body.

(7) In the method for manufacturing a honeycomb structure of the present embodiment, the moisture is added to an adhesive paste to be used in the bonding process to prepare a base adhesive paste serving as a material for the base adhesive paste.

Since the adhesive paste to be used in the bonding process and the base adhesive paste are different from each other only in their moisture contents, the adhesive layers having the same composition can be formed by drying these two kinds of adhesive pastes. When the adhesive layers to be formed have the same composition, no border is substantively formed in the honeycomb structure. Therefore, when such a honeycomb structure is used as a catalyst supporting carrier, the resulting adhesive layer tends to eliminate peeling and the like between the adhesive layers.

The following description will discuss Examples that specifically disclose the third embodiment of the third invention. Here, the third invention is not intended to be limited only by these Examples.

In the present Examples, the filling property of the adhesive paste was observed by following the same processes as in the Examples of the method for manufacturing a honeycomb structure of the first embodiment.

### EXAMPLE 8

Honeycomb fired bodies were manufactured by following the same processes as in Example 1.

Here, an adhesive paste prior to the addition of a water retention agent, prepared in Example 1 (the same adhesive paste used in Comparative Example 1), was prepared as the adhesive paste.

Moreover, 100 parts by weight of water was added to 100 parts by weight of the adhesive paste to prepare a base adhesive paste.

Subsequently, the base adhesive paste was applied to the side faces of the honeycomb fired body to form base adhesive paste layer.

Here, the thickness of the formed base adhesive paste layer was 200 μm.

The observation of the filling property was carried out by following the same processes as in Example 1 using the honeycomb fired body with the base adhesive paste layer formed thereon and the adhesive paste.

The results show that the filling property was good.

The above-mentioned result indicates that the formation of the base adhesive paste layer on the side face of the honeycomb fired body makes it easier to fill with the adhesive paste with high working efficiency.

### Other Embodiments

In the embodiments described above, the filling property of the adhesive paste has been improved respectively by using the water retention adhesive paste, forming the water repellent layer or forming the base adhesive paste layer, respectively. Some of these methods may be used in combination.

For example, the water repellent layer may be preliminarily formed on the side face of the honeycomb fired body, and the water retention adhesive paste is used as the adhesive paste.

Although not particularly limited, the amount of the water retention agent to be added relative to 100 parts by weight of the adhesive paste is preferably at least about 0.05 parts by weight and at most about 2 parts by weight.

In the case where the amount of addition of the water retention agent is less than about 0.05 parts by weight, the slightly larger amount of moisture moves from the water retention adhesive paste to the honeycomb fired body; in contrast, the amount of addition exceeding about 2 parts by weight fails to further improve the flowability of the water retention adhesive paste; therefore, the amount of addition is preferably at least about 0.05 parts by weight and at most about 2 parts by weight.

Although not particularly limited, the thickness of the water repellent layer to be formed on the side face of the honeycomb fired body is preferably about 200 μm or less.

The thickness of the water repellent layer of about 200 μm or less tends not to cause degradation of adhesive strength between the adhesive layer and the honeycomb fired body.

Although not particularly limited, the thickness of the base adhesive paste layer is preferably at least about 100 μm and at most about 300 μm.

In the case where the thickness of the base adhesive paste layer is about 100 μm or more, a small amount of the moisture contained in the adhesive paste tends not to penetrate through the base adhesive paste layer, and be absorbed into the honeycomb fired body; in contrast, the thickness of the base adhesive paste layer of about 300 μm or less tends not to make the width of the gap narrower, making it easier to fill it with the adhesive paste.

Moreover, the method for forming the water repellent layer or the base adhesive paste layer is not limited to the applying method, and a general coating method may be used. For example, a coating method such as methods using a coater or a spray may be used.

The shape of the honeycomb structure to be formed by the method for manufacturing a honeycomb structure according to the embodiments of the first to third inventions is not particularly limited to a cylindrical shape, and may be a desired pillar shape such as a cylindroid shape and a polygonal pillar shape.

Moreover, the thickness of the adhesive layer to be formed in the method for manufacturing a honeycomb structure according to the embodiments of the first to third inventions is preferably at least about 0.5 mm and at most about 5 mm.

The thickness of the adhesive layer of about 0.5 mm or more tends to provide a sufficient strength. Moreover, since the adhesive layer corresponds to a portion that does not function as a catalyst supporting carrier, the thickness of the adhesive layer of about 5 mm or less tends not to cause a reduction in a specific surface area of the honeycomb structure per unit volume. Consequently, it tends to result in sufficiently high dispersion of the catalyst, in use of the honeycomb structure as a catalyst supporting carrier for converting exhaust gases.

In addition, the thickness of the adhesive layer of about 5 mm or less tends not to cause a high pressure loss.

Examples of the inorganic particles contained in the raw material composition are particles including alumina, silica, zirconia, titania, ceria, mullite, zeolite or the like. Each of these particles may be used alone, or two or more kinds of these may be used in combination.

Out of these, in particular, alumina particles or ceria particles are preferably used.

Examples of at least one of the inorganic fibers and whiskers contained in the raw material composition are alumina, silica, silicon carbide, silica-alumina, glass, potassium titanate and the like. Each of these may be used alone, or two or more kinds of these may be used in combination. Out of at least one of the above-mentioned inorganic fibers and whiskers, aluminum borate whiskers are more preferably used.

Here, in the present description, the inorganic fibers and whiskers are referred to as those having an average aspect ratio (length/diameter) of more than about 5. Moreover, the preferable average aspect ratio of the inorganic fibers and whiskers is at least about 10 and at most about 1000.

With respect to the inorganic binder contained in the raw material composition, inorganic sol, clay-based binder and the like may be used, and specific examples of the inorganic sol include alumina sol, silica sol, titania sol, water glass and the like. Moreover, specific examples of the clay-based binder include clays of the polychain-type structure, such as white clay, kaolin, montmorillonite, sepiolite and attapulgite, and the like. Each of these may be used alone, or two or more kinds of these may be used in combination.

Out of these, at least one kind selected from a group consisting of alumina sol, silica sol, titania sol, water glass, sepiolite and attapulgite is preferably used.

The inorganic sol, the clay-based binder and the like contain moisture, and the moisture contained therein is removed by heating and the like to obtain remaining inorganic components as an inorganic binder.

With respect to the amount of the inorganic particles contained in the raw material composition, the lower limit is preferably about 30% by weight, more preferably about 40% by weight, further more preferably about 50% by weight.

In contrast, the upper limit thereof is preferably about 97% by weight, more preferably about 90% by weight, further more preferably about 80% by weight, still further more preferably about 75% by weight.

The content of the inorganic particles of about 30% by weight or more tends not to make the amount of inorganic particles that contribute to improvements of the specific surface area relatively smaller, with the result that the specific surface area of the honeycomb structure (honeycomb fired body) tends not to become smaller, making it easier to highly disperse a catalyst component upon supporting the catalyst component; in contrast, the content of the inorganic particles of about 97% by weight or less tends not to make the amount of at least one of the inorganic fibers and whiskers that contribute to improvements in strength relatively smaller, and this tends not to result in a reduction in the strength of the honeycomb fired body.

With respect to the total amount of at least one of the inorganic fibers and whiskers contained in the raw material composition, the lower limit is preferably about 3% by weight, more preferably about 5% by weight, further more preferably about 8% by weight. In contrast, the upper limit is preferably about 70% by weight, more preferably about 50% by weight, further more preferably about 40% by weight, still further more preferably about 30% by weight.

The content of at least one of the inorganic fibers and whiskers of about 3% by weight or more tends not to deteriorate the strength of the honeycomb fired body; in contrast, the content of at least one of the inorganic fibers and whiskers of about 50% by weight or less tends not to make the amount of inorganic particles that contribute to improvements of the specific surface area relatively smaller, with the result that the specific surface area of the honeycomb structure (honeycomb fired body) tends not to become smaller, making it easier to highly disperse a catalyst component upon supporting the catalyst component.

With respect to the amount of the inorganic binder contained in the raw material composition, the lower limit thereof as solids content is preferably about 5% by weight relative to the total amount of the solid components including the inorganic particles, at least one of the inorganic fibers and whiskers, and the inorganic binder contained in the raw material composition, more preferably about 10% by weight, further more preferably about 15% by weight. In contrast, the upper limit thereof is preferably about 50% by weight, more preferably about 40% by weight, further more preferably about 35% by weight.

The amount of the inorganic binder of about 5% by weight or more as solids content tends not to deteriorate the strength of the manufactured honeycomb fired body; in contrast, the amount of the inorganic binder of 50% by weight or less as solids content tends not to deteriorate the moldability of the raw material composition.

Although not particularly limited, examples of the plasticizer contained in the raw material composition include glycerin and the like. Moreover, although not particularly limited, examples of the lubricant include polyoxy alkylene-based compounds, such as polyoxy ethylene alkylether, polyoxy propylene alkylether and the like.

Specific examples of the lubricant are polyoxy ethylene monobutyl ether or polyoxy propylene monobutyl ether.

Here, the plasticizer and lubricant may not be included in the raw material composition on demand.

Moreover, although not particularly limited, examples of the dispersant contained in the raw material composition are water, an organic solvent (benzene and the like), alcohol (methanol and the like) and the like.

Although not particularly limited, examples of the forming auxiliary are ethylene glycol, dextrin, fatty acid, fatty acid soap, polyalcohol and the like.

With respect to the inorganic particles, at least one of inorganic fibers and whiskers, and inorganic binder to be contained in the adhesive paste, those inorganic particles, at least one of inorganic fibers and whiskers, and inorganic binder used as the raw material compositions may be desirably used.

Moreover, an inorganic binder may be contained in the adhesive paste. The organic binder is not particularly limited, and examples thereof are polyvinyl alcohol, methylcellulose, ethylcellulose, carboxy methylcellulose and the like.

Moreover, a catalyst supporting process for supporting a catalyst on a manufactured honeycomb structure may be carried out.

Although not particularly limited, examples of the catalyst (catalyst metal) to be supported on the honeycomb structure of the present embodiment are noble metal, alkali metal, alkali earth metal and the like.

Each of these may be used alone, or two or more kinds of these may be used in combination.

Here, the timing at which the catalyst is supported is not particularly limited, and the catalyst may be supported after a honeycomb structure has been manufactured, or may be supported on inorganic particles in a state of a raw material used for a honeycomb fired body. Although not particularly limited, examples of the method of supporting a catalyst may be an immersing method and the like.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A method for manufacturing a honeycomb structure, said method comprising:
molding a raw material composition to manufacture a plurality of honeycomb molded bodies each having a number of cells longitudinally placed substantially in parallel with one another with a cell wall interposed therebetween;
firing said plurality of honeycomb molded bodies to manufacture a plurality of honeycomb fired bodies;
preparing a water retention adhesive paste containing a water retention agent; and
bonding the plurality of honeycomb fired bodies to one another by using said water retention adhesive paste and forming an adhesive layer to manufacture a honeycomb aggregated body.

2. The method for manufacturing a honeycomb structure according to claim 1,
wherein said water retention agent comprises at least one of a water absorbing polymer, a high porosity adhesive, montmorillonite, vermiculite and saponite.

3. The method for manufacturing a honeycomb structure according to claim 2,
wherein said water absorbing polymer comprises sodium polyacrylate.

4. The method for manufacturing a honeycomb structure according to claim 1,
wherein said raw material composition comprises inorganic particles, at least one of inorganic fibers and whiskers, and an inorganic binder.

5. The method for manufacturing a honeycomb structure according to claim 4,
wherein said inorganic particles comprise at least one of alumina, silica, zirconia, titania, ceria, mullite and zeolite.

6. The method for manufacturing a honeycomb structure according to claim 4,
wherein said at least one of inorganic fibers and whiskers comprises at least one of alumina, silica, silicon carbide, silica-alumina, glass, potassium titanate and aluminum borate.

7. The method for manufacturing a honeycomb structure according to claim 4,
wherein said inorganic binder includes at least one of alumina sol, silica sol, titania sol, water glass, sepiolite and attapulgite.

8. The method for manufacturing a honeycomb structure according to claim 4,
wherein an average aspect ratio of said inorganic fibers or said whiskers is at least about 10 and at most about 1000.

9. The method for manufacturing a honeycomb structure according to claim 4,
wherein an amount of said inorganic particles is at least about 30% by weight and at most about 97% by weight.

10. The method for manufacturing a honeycomb structure according to claim 4,
wherein a total amount of said at least one of inorganic fibers and whiskers is at least about 3% by weight and at most about 70% by weight.

11. The method for manufacturing a honeycomb structure according to claim 4,
wherein an amount of said inorganic binder as solids content is at least about 5% by weight and at most about 50% by weight relative to a total amount of the solid components including said inorganic particles, said at least one of inorganic fibers and whiskers, and said inorganic binder.

12. The method for manufacturing a honeycomb structure according to claim 1, further comprising:
cutting a periphery of said honeycomb aggregated body to manufacture a ceramic block.

13. The method for manufacturing a honeycomb structure according to claim 12, further comprising:
applying a sealing material paste to an outer peripheral face of said ceramic block and then drying and solidifying said sealing material paste to form a coat layer on a periphery of said ceramic block.

14. The method for manufacturing a honeycomb structure according to claim 1,
wherein at least about 0.05 parts by weight and at most about 2 parts by weight of said water retention agent is added relative to 100 parts by weight of an adhesive paste to form said water retention adhesive paste.

15. The method for manufacturing a honeycomb structure according to claim 1,
wherein a thickness of said adhesive layer is at least about 0.5 mm and at most about 5 mm.

16. The method for manufacturing a honeycomb structure according to claim 1, further comprising:
supporting a catalyst on the manufactured honeycomb structure.

17. The method for manufacturing a honeycomb structure according to claim 16,
wherein said catalyst comprises noble metal, alkali metal, or alkali earth metal.

18. A method for manufacturing a honeycomb structure, said method comprising:
molding a raw material composition to manufacture a plurality of honeycomb molded bodies each having a number of cells longitudinally placed substantially in parallel with one another with a cell wall interposed therebetween;
firing said plurality of honeycomb molded bodies to manufacture a plurality of honeycomb fired bodies;
forming a water repellent layer on a side face of each of said plurality of honeycomb fired bodies; and
bonding said plurality of honeycomb fired bodies to one another by using an adhesive paste and forming an adhesive layer to manufacture a honeycomb aggregated body.

19. The method for manufacturing a honeycomb structure according to claim 18,
wherein a water repellent agent is applied to the side face of each of said plurality of honeycomb fired bodies to form said water repellent layer.

20. The method for manufacturing a honeycomb structure according to claim 19,
wherein said water repellent agent comprises at least one of silicone oil, wax, and glass.

21. The method for manufacturing a honeycomb structure according to claim 18,
wherein said raw material composition comprises inorganic particles, at least one of inorganic fibers and whiskers, and an inorganic binder.

22. The method for manufacturing a honeycomb structure according to claim 21,
wherein said inorganic particles comprise at least one of alumina, silica, zirconia, titania, ceria, mullite and zeolite.

23. The method for manufacturing a honeycomb structure according to claim 21,
wherein said at least one of inorganic fibers and whiskers comprises at least one of alumina, silica, silicon carbide, silica-alumina, glass, potassium titanate and aluminum borate.

24. The method for manufacturing a honeycomb structure according to claim 21,
wherein said inorganic binder includes at least one of alumina sol, silica sol, titania sol, water glass, sepiolite and attapulgite.

25. The method for manufacturing a honeycomb structure according to claim 21,
wherein an average aspect ratio of said inorganic fibers or said whiskers is at least about 10 and at most about 1000.

26. The method for manufacturing a honeycomb structure according to claim 21,
wherein an amount of said inorganic particles is at least about 30% by weight and at most about 97% by weight.

27. The method for manufacturing a honeycomb structure according to claim 21,
wherein a total amount of said at least one of inorganic fibers and whiskers is at least about 3% by weight and at most about 70% by weight.

28. The method for manufacturing a honeycomb structure according to claim 21,
wherein an amount of said inorganic binder as solids content is at least about 5% by weight and at most about 50% by weight relative to a total amount of the solid components including said inorganic particles, said at least one of inorganic fibers and whiskers, and said inorganic binder.

29. The method for manufacturing a honeycomb structure according to claim 18, further comprising:
cutting a periphery of said honeycomb aggregated body to manufacture a ceramic block.

30. The method for manufacturing a honeycomb structure according to claim 29, further comprising:
applying a sealing material paste to an outer peripheral face of said ceramic block and then drying and solidifying said sealing material paste to form a coat layer on a periphery of said ceramic block.

31. The method for manufacturing a honeycomb structure according to claim 18,
wherein a thickness of said water repellent layer is about 200 μm or less.

32. The method for manufacturing a honeycomb structure according to claim 18,
wherein said water repellent layer is formed by using a coater or a spray.

33. The method for manufacturing a honeycomb structure according to claim 18,
wherein a thickness of said adhesive layer is at least about 0.5 mm and at most about 5 mm.

34. The method for manufacturing a honeycomb structure according to claim 18, further comprising:
supporting a catalyst on the manufactured honeycomb structure.

35. The method for manufacturing a honeycomb structure according to claim 34,
wherein said catalyst comprises noble metal, alkali metal, or alkali earth metal.

36. A method for manufacturing a honeycomb structure, said method comprising:
molding a raw material composition to manufacture a plurality of honeycomb molded bodies each having a number of cells longitudinally placed substantially in parallel with one another with a cell wall interposed therebetween;
firing said plurality of honeycomb molded bodies to manufacture a plurality of honeycomb fired bodies;
forming a base adhesive paste layer having a moisture content on a side face of each of said plurality of honeycomb fired bodies; and
bonding the plurality of honeycomb fired bodies to one another by using an adhesive paste and forming an adhesive layer to manufacture a honeycomb aggregated body.

37. The method for manufacturing a honeycomb structure according to claim 36,
wherein moisture is added to said adhesive paste used in said bonding to prepare a base adhesive paste serving as a material for said base adhesive paste layer.

38. The method for manufacturing a honeycomb structure according to claim 37,
wherein said base adhesive paste is applied to each side face of each of said plurality of honeycomb fired bodies to form said base adhesive paste layer.

39. The method for manufacturing a honeycomb structure according to claim 36,
wherein said raw material composition comprises inorganic particles, at least one of inorganic fibers and whiskers, and an inorganic binder.

40. The method for manufacturing a honeycomb structure according to claim 39,
wherein said inorganic particles comprise at least one of alumina, silica, zirconia, titania, ceria, mullite and zeolite.

41. The method for manufacturing a honeycomb structure according to claim 39,
wherein said at least one of inorganic fibers and whiskers comprises at least one of alumina, silica, silicon carbide, silica-alumina, glass, potassium titanate and aluminum borate.

42. The method for manufacturing a honeycomb structure according to claim 39,
wherein said inorganic binder includes at least one of alumina sol, silica sol, titania sol, water glass, sepiolite and attapulgite.

43. The method for manufacturing a honeycomb structure according to claim 39,
wherein an average aspect ratio of said inorganic fibers or said whiskers is at least about 10 and at most about 1000.

44. The method for manufacturing a honeycomb structure according to claim 39,
wherein an amount of said inorganic particles is at least about 30% by weight and at most about 97% by weight.

45. The method for manufacturing a honeycomb structure according to claim 39,
wherein a total amount of said at least one of inorganic fibers and whiskers is at least about 3% by weight and at most about 70% by weight.

46. The method for manufacturing a honeycomb structure according to claim 39,
wherein an amount of said inorganic binder as solids content is at least about 5% by weight and at most about 50% by weight relative to a total amount of the solid components including said inorganic particles, said at least one of inorganic fibers and whiskers, and said inorganic binder.

47. The method for manufacturing a honeycomb structure according to claim 36, further comprising:
cutting a periphery of said honeycomb aggregated body to manufacture a ceramic block.

48. The method for manufacturing a honeycomb structure according to claim 47, further comprising:
applying a sealing material paste to an outer peripheral face of said ceramic block and then drying and solidifying said sealing material paste to form a coat layer on a periphery of said ceramic block.

49. The method for manufacturing a honeycomb structure according to claim 36,
wherein a thickness of said base adhesive paste layer is at least about 100 μm and at most about 300 μm.

50. The method for manufacturing a honeycomb structure according to claim 36,
wherein said base adhesive paste layer is formed by using a coater or a spray.

51. The method for manufacturing a honeycomb structure according to claim 36,
wherein a thickness of said adhesive layer is at least about 0.5 mm and at most about 5 mm.

52. The method for manufacturing a honeycomb structure according to claim 36, further comprising:
supporting a catalyst on the manufactured honeycomb structure.

53. The method for manufacturing a honeycomb structure according to claim 52,
wherein said catalyst comprises noble metal, alkali metal, or alkali earth metal.
